(19) United States
(12) Patent Application Publication
(10) Pub. No.: US 2011/0132688 A1
(43) Pub. Date: Jun. 9, 2011

(54) COUPLING WITH ELECTRIC CONTACTS FOR AN OIL/AIR MIXTURE

(75) Inventor: Arthur Allerdings, Wenden (DE)

(73) Assignee: SMS SIEMAG AKTIENGESELLSCHAFT, Dusseldorf (DE)

(21) Appl. No.: 13/056,286

(22) PCT Filed: Jul. 30, 2009
(86) PCT No.: PCT/EP2009/005527

§ 371 Date: Feb. 7, 2011

(30) Foreign Application Priority Data
Jul. 30, 2008 (DE) 10 2008 035 482.1
May 2, 2009 (DE) 10 2009 019 783.4

(51) Int. Cl. H01R 13/40; F16N 29/00; F16N 21/00

(52) U.S. Cl. 184/7.4; 439/586

(57) ABSTRACT

The invention relates to a coupling for an oil/air mixture used in oil/air lubrication, and a method for the use thereof, wherein the oil/air coupling also comprises electric contacts (3, 13) such that in addition to the transmission of the oil/air mixture, the coupling may also conduct electric current via electric connections (3, 13). Such an arrangement facilitates, among other things, an automated coupling or decoupling during a roller change in a rolling mill.

### TECHNICAL FIELD

The invention concerns a coupling for an oil/air mixture for use in oil/air lubrication and use of the coupling in a method, wherein the coupling additionally has electric contacts, so that the coupling can not only transmit the oil/air mixture but also conduct electric current via electric connections. In particular, a coupling of this type can be used in a plate structure in a roll stand.

### PRIOR ART

The prior art includes only couplings for oil/air lubrication or an oil/air mixture that allow the oil/air mixture to be transmitted.

Especially in the field of rolling mill engineering, bearings of rolls, for example, are being operated more and more with oil/air lubrication instead of oil lubrication. Above all, this is happening due to the smaller amounts of oil that are required. In addition, return is eliminated in oil/air lubrication. In the case of oil lubrication, the condition of the bearings and their lubrication can be monitored by measuring the return temperature of the oil. In the case of oil/air lubrication, monitoring the temperature of the oil return is no longer possible, because there is no oil return. Therefore, thermocouples must be installed directly in the chocks of the rolls, but these then require their own current and signal transmission line. If thermocouples or vibration pickups are installed in the bearings, then these must first be manually disconnected by plugs before the roll change is carried out and then manually reconnected after the roll change. Aside from the extra work this entails, it could accidentally happen that the workers fail to reconnect the plugs. This would have the possible consequence of serious damage to the roll bearings, which could have been avoided by proper monitoring of the vibrations and/or the temperature of the roll bearings. The connection of the oil/air coupling has previously been made via a coupling in a plate structure. However, if another coupling for an electric line is provided in the plate structure, this likewise makes the coupling and decoupling during regular roll changes more difficult. Moreover, automatic coupling and decoupling is made more difficult.

The German utility patent DE 85 32 752 U describes a coupling device for pressure medium lines with oil/air lubrication in roll stands. However, this coupling device does not make it possible for the lubricant coupling to transmit electric currents at the same time. Instead, this document only provides for visual monitoring of the situation with the rolls.

Accordingly, the technical objective of the present invention is to eliminate the disadvantages described above.

### DISCLOSURE OF THE INVENTION

The stated objective is achieved by the invention described below, which comprises the following:

A coupling for an oil/air lubrication system, said coupling having a first coupling half with a first housing and a first hose coupling and a second coupling half with a second housing and a second hose coupling, wherein the two coupling halves can be coupled with each other, so that an oil/air mixture that is flowing through the first hose coupling flows through the coupled coupling halves and into the second hose coupling, which oil/air coupling is characterized in that, in addition, a first electric connection is arranged in the first coupling half, and a second electric connection is arranged in the second coupling half in such a way that when the first and second coupling halves are coupled, the two electric connections are likewise coupled, so that an electric current can flow through the coupled electric connections.

The electric current, for example, of a thermocouple or other sensor, can thus also be transmitted by the oil/air coupling. Now all that is further required is a coupling that can also be optionally used in connection with an automatic roll change.

In another preferred embodiment, each electric connection is arranged concentrically within the housing of the respective coupling half.

In another preferred embodiment, the housing of one of the coupling halves contains an element that can move in the coupling direction and is connected with the given electric connection. When the coupling is uncoupled, this moving element seals the housing of the coupling half in the coupling direction, so that oil/air mixture cannot flow out of the coupling half.

In another preferred embodiment, the electric connections are arranged in such a way in the coupling direction that when the two coupling halves are coupled, the electric connections are coupled first, and only then does the moving element that is connected with the respective electric connection open a passage for the oil/air mixture.

In another preferred embodiment, the electric connections are sealed after they have been coupled, and only then does the moving element open the passage for the oil/air mixture.

A preferred embodiment of this type has the advantage that the electric connections are protected from the oil/air mixture and cannot come into contact with it.

In another preferred embodiment, a second moving element is provided in the second coupling half. When the coupling is uncoupled, this moving element seals the housing of the second coupling half in the coupling direction, so that oil/air mixture cannot flow out of the coupling half.

In another preferred embodiment, during the coupling of the first and second coupling halves, the housing of the first coupling half moves the second moving element of the second coupling half in the coupling direction, so that a passage for the oil/air mixture opens.

In another preferred embodiment, the coupled coupling can be rotated about its longitudinal axis. This feature simplifies the coupling and decoupling operations, since there is no particular radial preferred direction with respect to the coupling mechanism.

In another preferred embodiment, a passage for the oil/air mixture is present between the electric connections and the inside wall of the housings of the coupling halves.

In another preferred embodiment, at least one electric connection can move in the longitudinal direction.

In another preferred embodiment, at least one of the electric connections is placed under tension in the coupling direction by a spring, which is held by a crosspiece that extends essentially perpendicularly to the inside wall of the housing.

In another preferred embodiment, the crosspiece has at least one opening for the oil/air mixture.

In another preferred embodiment, the electric connections of at least one coupling half are designed shorter in the coupling direction than the housings of the coupling halves, so that the housings of the coupling halves couple with each other before the electric connections couple.

This type of preferred arrangement of the electric connections has the advantage that the electric contacts are not bent, broken off or otherwise damaged by a coupling operation that deviates slightly from the coupling direction.

In another preferred embodiment, the first electric connection within the first coupling half is designed as a plug, and the second electric connection within the second coupling half is designed as a socket.

In another preferred embodiment, electric lines are brought out from the rear side of the coupling housings essentially parallel to the hose couplings.

A preferred feature of this description leads to further simplification of the coupling and decoupling of the oil/air coupling, since the electric cables require space only in the coupling direction.

In another preferred embodiment, the electric lines are led through the housings via a screwed cable connector, or they are cast with the housings.

The invention also includes a method for simultaneously monitoring the lubrication and the transmission of lubricants of rolls in a mill train, in which roll necks of the rolls are supported in a bearing mounted in a chock. This method is characterized in that the chock is provided with a drill hole, in which are installed a vibration sensor and/or a temperature sensor, which are connected by cables with a coupling of the invention, so that the oil/air mixture and the electric currents are coupled, transmitted, and uncoupled by the coupling.

With the coupling claimed by the invention, this method allows the simultaneous transmission of the electric currents or signals and the lubricants. Due to the arrangement of the sensors in the chocks, monitoring of the roll bearings is now always possible when the coupling is in its coupled state. The coupling and decoupling of all lines can be accomplished manually or especially automatically in a single operation.

### BRIEF DESCRIPTION OF THE DRAWINGS

The drawings of specific embodiments are briefly described below.

FIG. 1 is a cross-sectional drawing of a roll of a mill train, showing the installed position of a sensor in the chock.

FIG. 2 is a cross-sectional drawing of a coupled coupling of a first embodiment of the invention.

FIG. 3 is a cross-sectional drawing of an uncoupled coupling of another embodiment of the invention.

FIG. 4 is a cross-sectional drawing of the coupled coupling of Figure.

### DETAILED DESCRIPTION OF THE EMBODIMENTS

It should first be pointed out as a general observation that the terms “first” and “second” in the following description are used only for the sake of clarity and do not rule out other possible formulations or orders of naming.

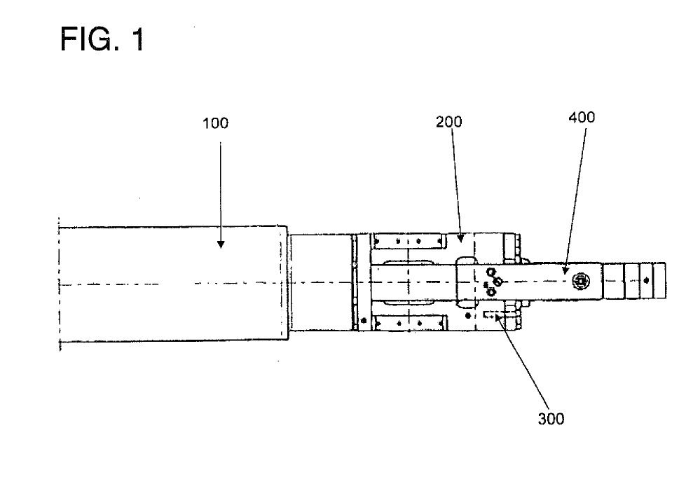

FIG. 1 shows a cross section of a roll 100 of a mill train. The roll 100 has a roll neck 400, which can rotate in a roll bearing held in a stationary chock 200. The merely schematic drawing shows half of the roll. The chock 200 contains a drill hole 300, in which a sensor (not shown) can be mounted. The electric connection of such a sensor can then be connected with a coupling, e.g., in the plate structure of the roll stand. The roll 100 can be, for example, a work roll, a backup roll, or an intermediate roll. Accordingly, the chock 200 is provided with drill holes 300 for sensors, especially vibration sensors or temperature sensors. Sensors are installed in these drill holes and are connected with an automatically or manually coupled coupling for an oil/air lubrication system or other lubrication system or supply system that is provided with electric connections. The drill hole 300 for the aforesaid sensors is preferably formed parallel to the roll axis but can also be formed at an angle to the roll axis. A sensor mounted in this drill hole is preferably connected by a cable with a coupling of the invention, so that simultaneous transmission of the lubricants and the electric currents of the sensor is possible. It is also possible for one of the coupling halves to be built directly into the chock 200, so that an exposed cable is no longer needed between the coupling and sensor. In this case, the installation is equivalent to that of a sensor.

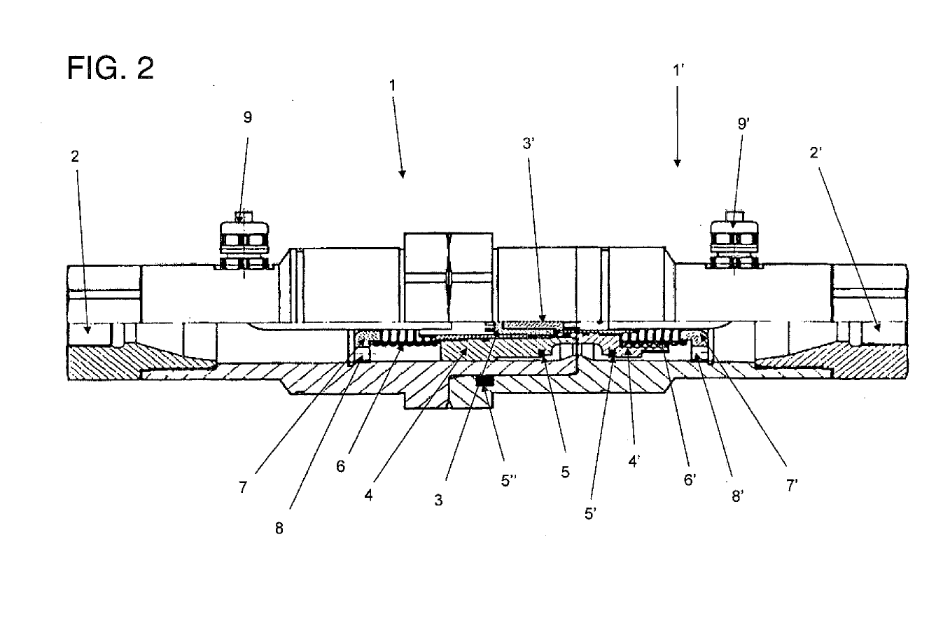

FIG. 2 shows an embodiment of a coupled coupling of the invention. The coupling has a first coupling half 1 and a second coupling half 1′, each of which contains connections 2, 2′ for an oil/air mixture. Inside the coupling, each coupling half 1, 1′ contains an electric connection 3, 3′ that is arranged coaxially and thus in the coupling direction. In the example illustrated here, these connections are designed as a plug 3′ and socket 3. Each of these electric connections 3, 3′ is connected with a moving element 4, 4′, whose principal purpose is to seal the uncoupled coupling. This moving element 4, 4′ can move in the coupling direction with the electric connection 3, 3′ inside the housing of the respective coupling half 1, 1′. The moving element 4, 4′ basically has an external shape that conforms to the inside of the coupling housing. In addition, the moving element 4, 4′ is provided with channels or openings or passages for the oil/air mixture. In particular, each moving element 4, 4′ and each electric connection 3, 3′ is stressed or tensioned by a spring 6, 6′, respectively, which is mounted coaxially in the coupling direction. The spring 6, 6′ is supported on a crosspiece 7, 7′, respectively, which extends perpendicularly to the housing of the respective coupling half 1, 1′. Each crosspiece 7, 7′ has one or more openings or passages 8, 8′ in the coupling direction, through which an oil/air mixture can flow. Seal 5″ serves the purpose of sealing the two halves of the housing when they are in their coupled state. The seals 5, 5′ serve the purpose of sealing the space between the respective moving element 4, 4′ and the housing of the respective coupling half 1, 1′ in the uncoupled state of the coupling. Seal 5″ also serves to seal the electric connections 3, 3′ in the coupled state. Electric lines or cables are led from the respective connections 3, 3′ axially in the direction of the respective connections 2, 2′ for the oil/air mixture and are then led out of the coupling housings perpendicularly to the coupling direction through screwed cable connectors 9, 9′, which can seal the housing. Optionally, it is also possible to cast the cables with the housings. In addition, it is also possible to lead each cable out of the respective housing through an opening that is essentially parallel to the coupling direction or at least has a direction component in that direction. The cables are generally flexible or movable to allow them to move with the electric connections 3, 3′ during the coupling and uncoupling operations. To prevent potential leakage currents, a nonconducting medium or oil can be used.

In the uncoupled state, the moving elements 4, 4′ are pressed or tensioned by the springs 6, 6′ towards the openings of the housing halves. The coupling halves 1, 1′ are sealed by the seals 5, 5′, so that oil cannot escape from the coupling. The electric connections 3, 3′ are set back in the coupling direction, so that they do not project from the housings of the coupling halves 1, 1′.

When the coupling is to be coupled, first the respective housings of the coupling halves 1, 1′ meet each other, so that the coupling halves 1, 1′ are sealed by the seal 5″. Only then do the electric connections 3, 3′ become coupled, but at this time the oil/air mixture is still unable to flow through the coupling, because this is prevented by the respective moving element 4, 4′ and the seals 5, 5′. Especially seals can also be provided between the electric connections and the moving elements to protect the electric connections from the surrounding medium or oil. Once the electric connections 3, 3′ are coupled, and the housings of the coupling halves 1, 1′ are moved farther towards each other in the coupling direction, the moving elements 4, 4′ move in the direction of the respective crosspieces 8, 8′ against the spring tension of the respective springs 6, 6′, so that a passage or an opening for the oil/air mixture is formed between each moving element 4, 4′ and the respective housing half. In particular, the form of the respective housing opening is slightly narrowed, so that after the movement of the moving element in the direction of the respective crosspiece, an opening for the oil/air mixture is formed between the moving element and the inside wall of the respective housing half. Optionally, it is also possible to provide drill holes or a recess in the coupling direction in each moving element on the side of the element that faces the crosspiece to ensure greater flow. In the case of uncoupling, the operations specified above proceed in the opposite order.

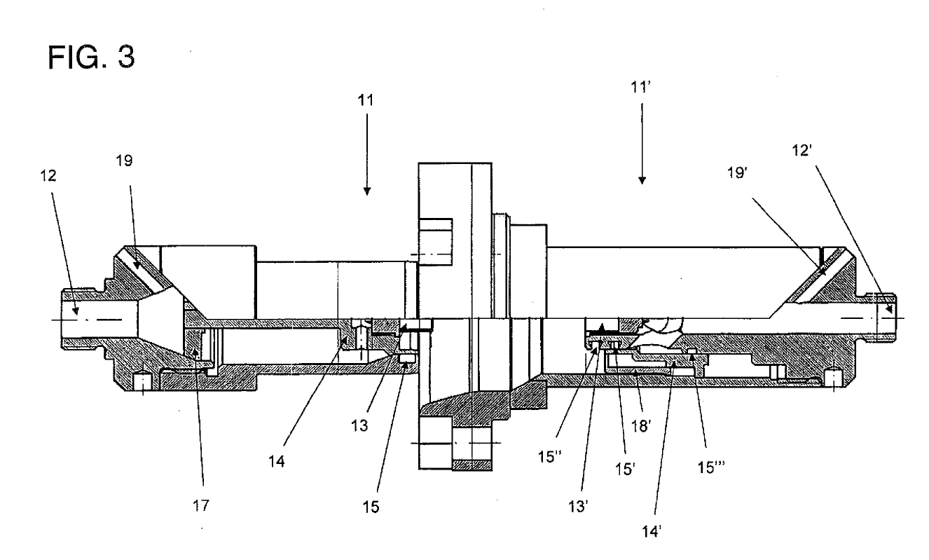

FIG. 3 shows another embodiment of a coupling of the invention. The coupling consists of the two coupling halves 11, 11′, and at the ends of each individual coupling half 11, 11′, there are connections 12, 12′, to which suitable pipes or hoses can be connected. Within each coupling half 11, 11′, there is a coaxially arranged electric connection 13, 13′ as well as a moving element 14, 14′. The element 14 is connected with the electric connection 13. In this regard, the connection 13 can be rigidly connected or flexibly connected with the element 14. In the illustrated example, the electric connection 13 is designed as a socket or an electric coupling, and the electric connection 13′ is a plug. However, the plug and socket can be interchanged. Seal 15 seals the coupling half 11 in the uncoupled state of the coupling. In this case, oil cannot escape from the coupling between the coupling housing of the coupling half 11 and the moving element 14. Seals 15′ and 15″ seal the coupling half 11′ in the uncoupled state. Oil cannot escape from the coupling half between the moving element 14′ and the electric connection 13′.

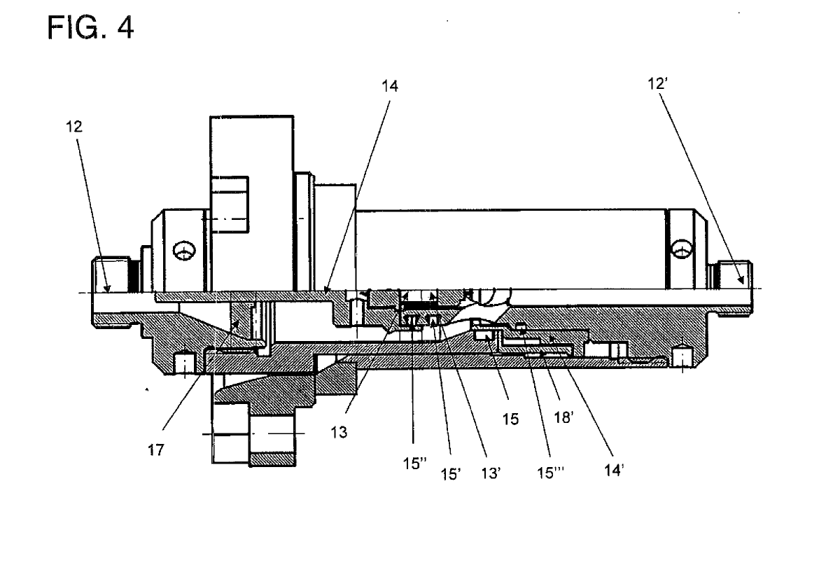

If the coupling halves 11, 11′ are moved towards each other to couple them, the two housing halves make contact with each other first. If the coupling halves 11, 11′ are moved farther in the coupling direction or axially towards each other, then the electric connections 13, 13′ are the next to become coupled. If the coupling halves 11, 11′ are moved still farther towards each other in the coupling direction, then the moving element 14 moves relative to the housing of the coupling half 11 opposite the coupling direction, so that an opening or a passage is formed between the moving element 14 and the coupling housing of the coupling half 11. In this connection, the moving element 14 can be axially tensioned by means of a spring or other elastic means. The spring is preferably supported or tensioned by a crosspiece 17. The crosspiece 17 is arranged essentially perpendicularly to the coupling direction and preferably has several openings that allow the oil/air mixture to pass through. The crosspiece can have especially the form of a rectangular solid or a cylinder, but other shapes are also possible. A part of the moving element 14 can be led axially through an opening in the crosspiece 17, and the crosspiece has a greater radial diameter than the part of the moving element 14 that can be moved through the opening in the crosspiece 17. In addition, during the coupling process, after the electric contacts have been coupled, the moving element 14′ in the coupling half 11′ is moved by the housing of the coupling half 11 via a moving part 18′ in the direction of the connection 12′, which causes a channel or an opening for the oil/air mixture to open. Among other purposes, the moving part 18′ serves to improve the transfer of the force of the housing of the coupling half 11 to the moving element 14′. The cables connected with each of the electric connections 13, 13′ are not shown in FIGS. 3 and 4. On the one hand, however, the cable for the electric connection 13 in the coupling half 11 runs essentially in the coupling direction from the electric connection 13, through an opening in the crosspiece 17 and through the drill hole 19, while, on the other hand, the cable for the electric connection 13′ in the coupling half 11′ runs essentially in the coupling direction from the electric connection 13′ to the drill hole 19′. The drill holes 19, 19′ are arranged in such a way that the projecting cables do not need much space in the radial direction. However, it is also possible to lead the drill holes 19, 19′ out of the housings in the coupling halves 11, 11′ essentially in the coupling direction, i.e., axially. In this connection, to guarantee tightness of the coupling, it is possible, for example, to cast the cables in the drill holes 19, 19′. However, the cables can also be led out of the housing in other ways if so desired, for example, through screwed cable connectors and/or to the side, as shown in FIG. 2.

FIG. 4 shows the same embodiment of the coupling that is shown in FIG. 3 but in the coupled state. This state is obtained when the process described above is followed. In addition, it is seen that the seal 15″ protects the electric contacts 13, 13′ from the surrounding medium or oil before the oil can get out of the coupling halves. The seals 15, 15′″ seal the housing from the outside and start to function before the opening for the oil/air mixture through the coupling halves 11, 11′ is opened. It is also seen that part of the moving element 14 has moved through an opening of the crosspiece 17. In this configuration, the oil/air mixture can flow through the coupling halves 11, 11′.

The embodiments of the coupling that have been described are preferably used in a mill train, but it is also possible to use these oil/air couplings in other technical fields. The radial diameter of the described couplings is generally less than 100 mm and preferably 50-80 mm. It is also possible to make this diameter greater for certain applications. The material used to make the coupling housing is preferably high-grade steel, but it is also possible to use any other material which can withstand the lubricant pressures that arise and which experiences little wear from the coupling and uncoupling operations. Moreover, it is possible to place a coupling half directly in a chock, for example, in a suitable drill hole.

### LIST OF REFERENCE NUMBERS

1 first coupling half
1′ second coupling half
2 first oil/air mixture connection
2′ second oil/air mixture connection
3 first electric connection
3′ second electric connection
4 first moving element
4′ second moving element
5, 5′, 5″ seals
6, 6′ springs
7, 7′ crosspieces
8, 8′ openings
9, 9′ screwed cable connectors
11 first coupling half
11′ second coupling half
12 first oil/air mixture connection
12′ second oil/air mixture connection
13 first electric connection
13′ second electric connection
14 first moving element
14′ second moving element
15, 15′15″, 15′″ seals
17 crosspiece
18′ moving part
19, 19′ drill holes
100 roll
200 chock
300 installed position of sensors
400 roll neck

1-17. (canceled)

18. A coupling for an oil/air lubrication system, comprising: coupling having a first coupling half with a first housing and a first hose coupling; a second coupling half with a second housing and a second hose coupling, wherein the two coupling halves can be coupled with each other, so that an oil/air mixture flowing through the first hose coupling flows through the coupled coupling halves and into the second hose coupling; a first electric connection arranged in the first coupling half; and a second electric connection arranged in the second coupling half so that when the first and second coupling halves are coupled, the first and second electric connections are coupled, so that an electric current can flow through the coupled electric connections.

19. The coupling in accordance with claim 18, wherein each electric connection is arranged concentrically within the housing of the respective coupling half.

20. The coupling in accordance with claim 18, wherein the housing of one of the coupling halves contains an element movable in a coupling direction, the coupling element being connected with the electric connection, whereby, when the coupling is uncoupled, the movable element seals the housing of the coupling half in the coupling direction, so that oil/air mixture cannot flow out of the coupling half.

21. The coupling in accordance with claim 20, wherein the electric connections are arranged in the coupling direction so that when the two coupling halves are coupled, the electric connections are coupled first, and only then does the movable element that is connected with the respective electric connection open a passage for the oil/air mixture.

22. The coupling in accordance with claim 21, wherein the electric connections are sealed after coupling, and only then does the movable element open the passage for the oil/air mixture.

23. The coupling in accordance with claim 20, wherein a second movable element is provided in the second coupling half so that when the coupling is uncoupled the second movable element seals the housing of the second coupling half in the coupling direction, so that oil/air mixture cannot flow out of the second coupling half.

24. The coupling in accordance with claim 23, wherein during coupling of the first and second coupling halves, the housing of the first coupling half moves the second moving element of the second coupling half in the coupling direction, so that a passage for the oil/air mixture opens.

25. The coupling in accordance with claim 18, wherein the coupled coupling is rotatable about a longitudinal axis.

26. The coupling in accordance with claim 18, wherein a passage for the oil/air mixture is present between the electric connections and an inside wall of the housings of the coupling halves.

27. The coupling in accordance with claim 18, wherein at least one of the electric connections is movable in a longitudinal direction.

28. The coupling in accordance with claim 26, wherein at least one of the electric connections is placed under tension in the coupling direction by a spring, which is held by a crosspiece that extends essentially perpendicularly to the inside wall of the housing.

29. The coupling in accordance with claim 28, wherein the crosspiece has at least one opening for the oil/air mixture.

30. The coupling in accordance with claim 18, wherein the electric connection of at least one of the coupling halves is designed shorter in the coupling direction than the housings of the coupling halves, so that the housings of the coupling halves couple with each other before the electric connections couple.

31. The coupling in accordance with claim 18, wherein the first electric connection within the first coupling half is a plug, and the second electric connection within the second coupling half is a socket.

32. The coupling in accordance with claim 18, wherein electric lines extend out from a rear side of the coupling housings essentially parallel to the coupling halves.

33. The coupling in accordance with claim 32, wherein the electric lines are led through the housings via a screwed cable connector, or are cast with the housings.

34. A method for simultaneously monitoring lubrication and transmission of lubricants of rolls in a mill train, wherein roll necks of the rolls are supported in a bearing mounted in a chock, wherein the chock is provided with a drill hole, in which are installed a vibration sensor and/or a temperature sensor, which are connected by cables with a coupling according to claim 18, so that an oil/air mixture and electric currents are coupled, transmitted, and uncoupled by the coupling.
